(19) United States
(12) Patent Application Publication
(10) Pub. No.: US 2002/0051674 A1
(43) Pub. Date: May 2, 2002

(54) Ring Binder mechanism

(75) Inventor: Chun Yuen To, Hong Kong (HK)

Correspondence Address: Robert R. Priddy, Attorney, Hall, Priddy, Myers & Vande Sande, Suite 200, 10220 River Road, Potomac, MD, 20854, US

(73) Assignee: World Wide Stationery Manufacturing Co. Limited

(21) Appl. No.: 09/812,889

(22) Filed: Mar. 21, 2001

Related U.S. Application Data
(63) Continuation-in-part of application No. 09/702,862, filed on Nov. 1, 2000.

(51) Int. Cl. B42F 3/04

(52) U.S. Cl. 402/36

(57) ABSTRACT

There is disclosed a housing for a ring binder mechanism, in which the housing includes a number of tabs extending generally towards a longitudinal axis of the housing. There is also disclosed a ring binder mechanism including a housing supporting a pair of carrier rails to which a number of half-rings are mounted, in which the housing includes a number of tabs extending generally towards a longitudinal axis of the housing, and the pair of carrier rails are movable between a first configuration in which the half-rings are closed and a second configuration in which the half-rings are open.

This application is a Continuation-In-Part of U.S. patent application Ser. No. 09/702,862 filed on Nov. 1, 2000.

This invention relates to loose-leaf retaining mechanism, which is also called ring binder mechanism, and a ring binder incorporating such a mechanism.

### BACKGROUND OF THE INVENTION

Conventionally, ring binder mechanisms include a curved upper steel plate casing supporting a pair of carrier rails for relative pivotal movement. To each of the carrier rails are fixedly secured a number of half-rings which are closed or opened in response to relative pivotal movement of the carrier rails. In particular, the two lateral edges of the upper casing are straight and are inwardly and downwardly bent to receive the outer lateral edges of the carrier rails, in order to support the rails for relative pivotal movement.

In order to reduce the cost of production, it has been proposed to use thinner steel plate for the upper casing. However, for each particular loading of ring binder mechanism, there is a limit to the thinness of the steel plate that can be used. If the steel plate is too thin, the upper casing may not be rigid enough to withstand the force exerted on it during the relative pivotal movement of the carrier rails, such that the upper casing may deform, or the whole ring binder mechanism cannot function.

It is thus an object of the present invention to provide an upper casing for a ring binder mechanism, and a ring binder mechanism incorporating such an upper casing, in which less material may be used without compromise on the strength of the upper casing and the ring binder mechanism.

Such and other objects of the invention will be apparent from the ensuing discussion.

### SUMMARY OF THE INVENTION

According to a first aspect of the present invention, there is provided a housing member for a ring binder mechanism, wherein said housing member includes a plurality of tab members extending generally towards a longitudinal axis of said housing member.

According to a second aspect of the present invention, there is provided a ring binder mechanism including a housing member supporting a pivotable lower structure to which a plurality of half-ring members are mounted, wherein said housing member includes a plurality of tab members extending generally towards a longitudinal axis of said housing member, and wherein said lower structure is movable between a first configuration in which said half-ring members are closed and a second configuration in which said half-ring members are open.

According to a third aspect of the present invention, there is provided a ring binder including a ring binder mechanism attached to a cover member, wherein said ring binder mechanism includes a housing member supporting a pivotable lower structure to which a plurality of half-ring members are mounted, wherein said housing member includes a plurality of tab members extending generally towards a longitudinal axis of said housing member, and wherein said lower structure is movable between a first configuration in which said half-ring members are closed and a second configuration in which said half-ring members are open.

### BRIEF DESCRIPTION OF THE DRAWINGS

Embodiments of the present invention, by way of examples only, are herein described, and with reference to the accompanying drawings, in which:

FIG. 1 is a top perspective view of a first embodiment of a ring binder mechanism according to the present invention in a ring-closed configuration;

FIG. 2 is an enlarged perspective view of a longitudinal end of the ring binder mechanism shown in FIG. 1;

FIG. 3 is a top perspective view of the ring binder mechanism shown in FIG. 1 in a ring-open configuration;

FIG. 4 is an enlarged perspective view of a longitudinal end of the ring binder mechanism shown in FIG. 3;

FIG. 5 is a bottom perspective view of the ring binder mechanism shown in FIG. 1 in a ring-closed configuration;

FIG. 6 is an enlarged perspective view of a longitudinal end of the ring binder mechanism shown in FIG. 5;

FIG. 7 is a bottom perspective view of the ring binder mechanism shown in FIG. 1 in a ring-open configuration;

FIG. 8 is an enlarged perspective view of a longitudinal end of the ring binder mechanism shown in FIG. 7;

FIG. 9 is a transverse sectional view of the ring binder mechanism shown in FIG. 1 in a ring-closed configuration;

FIG. 10 is a transverse sectional view of the ring binder mechanism shown in FIG. 1 in a ring-open configuration;

FIG. 11 is an exploded perspective view of the ring binder mechanism shown in FIG. 1;

FIG. 12 is an enlarged bottom perspective view of a longitudinal end of the housing of the ring binder mechanism shown in FIG. 1;

FIG. 13 is a top perspective view of a ring binder incorporating the ring binder mechanism shown in FIG. 1;

FIG. 14 is a top view showing the marking of a steel plate for making an upper casing for a conventional ring binder;

FIG. 15 is a top view showing the marking of a steel plate for making an upper casing for the ring binder mechanism shown in FIG. 1;

FIG. 16 is a top perspective view of a second embodiment of a ring binder mechanism according to the present invention in a ring-closed configuration;

FIG. 17 is an enlarged perspective view of a longitudinal end of the ring binder mechanism shown in FIG. 16;

FIG. 18 is a top perspective view of the ring binder mechanism shown in FIG. 16 in a ring-open configuration;

FIG. 19 is an enlarged perspective view of a longitudinal end of the ring binder mechanism shown in FIG. 18;

FIG. 20 is a bottom perspective view of the ring binder mechanism shown in FIG. 16 in a ring-closed configuration;

FIG. 21 is an enlarged perspective view of a longitudinal end of the ring binder mechanism shown in FIG. 20;

FIG. 22 is a bottom perspective view of the ring binder mechanism shown in FIG. 16 in a ring-open configuration;

FIG. 23 is an enlarged perspective view of a longitudinal end of the ring binder mechanism shown in FIG. 22;

FIG. 24 is a transverse sectional view of the ring binder mechanism shown in FIG. 16 in a ring-closed configuration;

FIG. 25 is a transverse sectional view of the ring binder mechanism shown in FIG. 16 in a ring-open configuration;

FIG. 26 is an exploded perspective view of the ring binder mechanism shown in FIG. 16;

FIG. 27 is an enlarged bottom perspective view of a longitudinal end of the housing of the ring binder mechanism shown in FIG. 16;

FIG. 28 is a top perspective view of a ring binder incorporating the ring binder mechanism shown in FIG. 16;

FIG. 29 is a top view showing the marking of a steel plate for making an upper casing for a conventional ring binder;

FIG. 30 is a top view showing the marking of a steel plate for making an upper casing for the ring binder mechanism shown in FIG. 16;

FIG. 31 is a top perspective view of a third embodiment of a ring binder mechanism according to the present invention in a ring-closed configuration;

FIG. 32 is a bottom perspective view of the ring binder mechanism shown in FIG. 31;

FIG. 33 is a top view showing the marking of a steel plate for making an upper casing for the ring binder mechanism shown in FIG. 31; and

FIG. 34 is a piece of steel platelet for making an upper casing for the ring binder mechanism shown in FIG. 31.

### DETAILED DESCRIPTION OF THE PREFERRED EMBODIMENTS

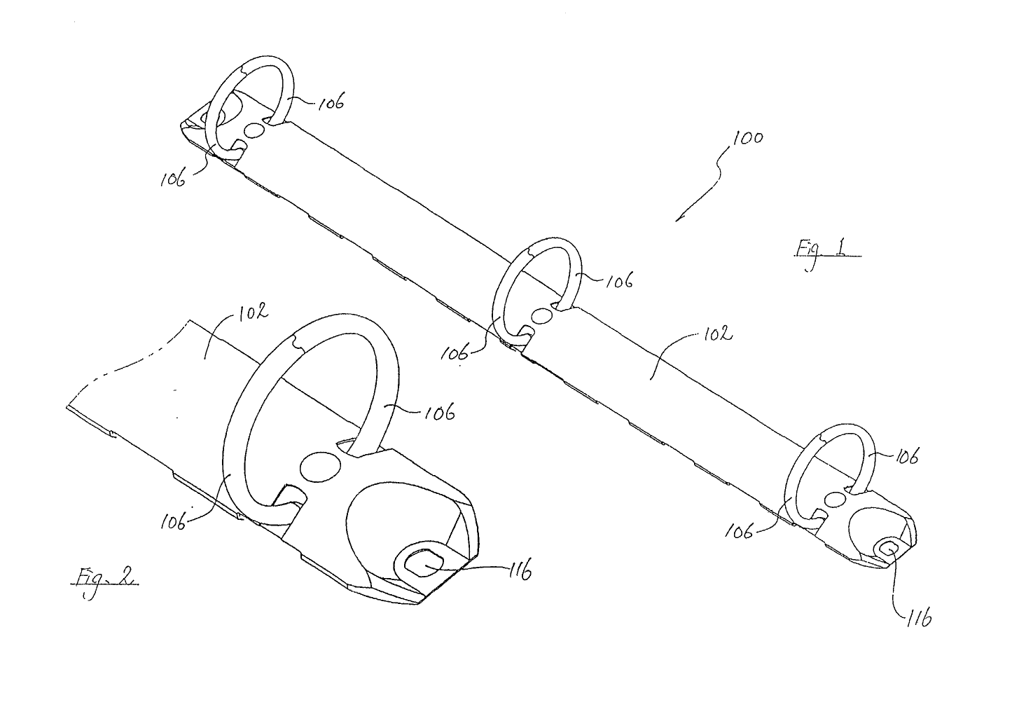

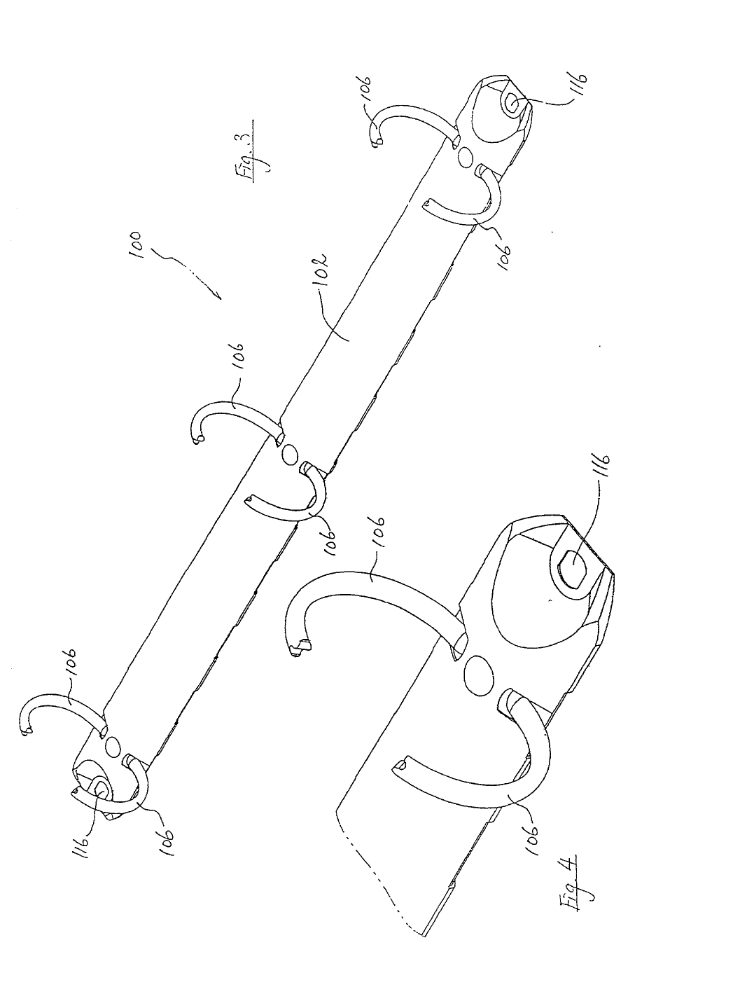

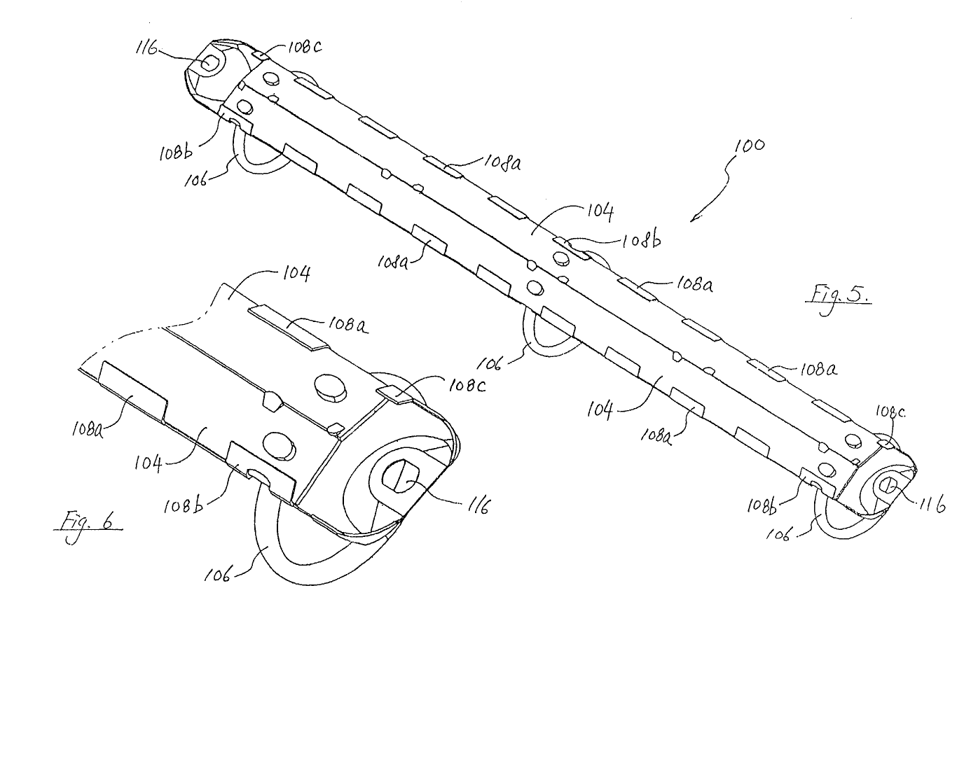

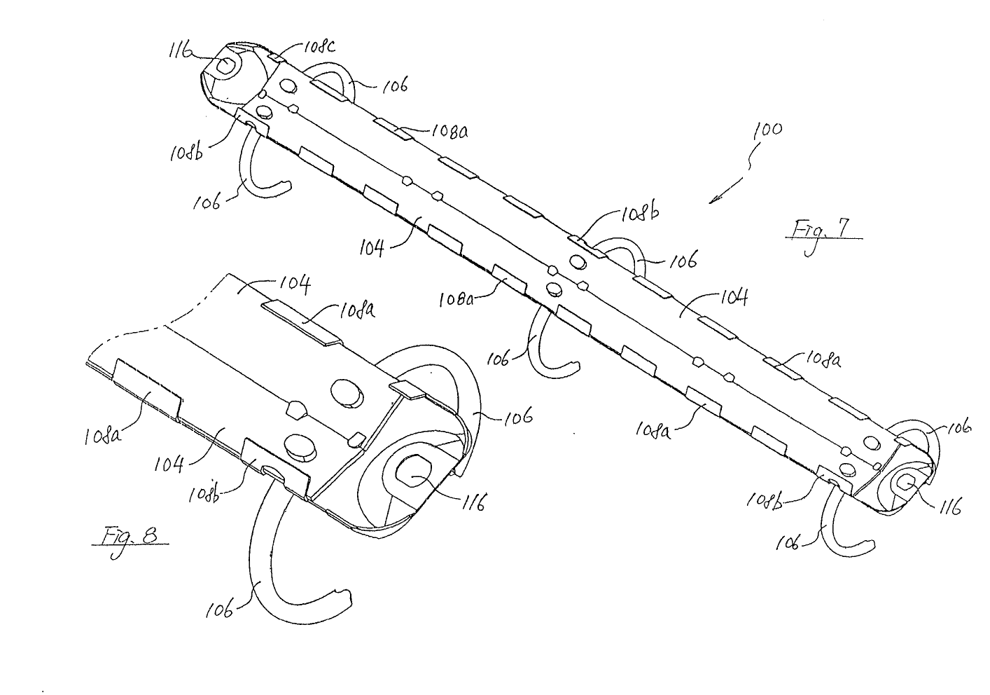

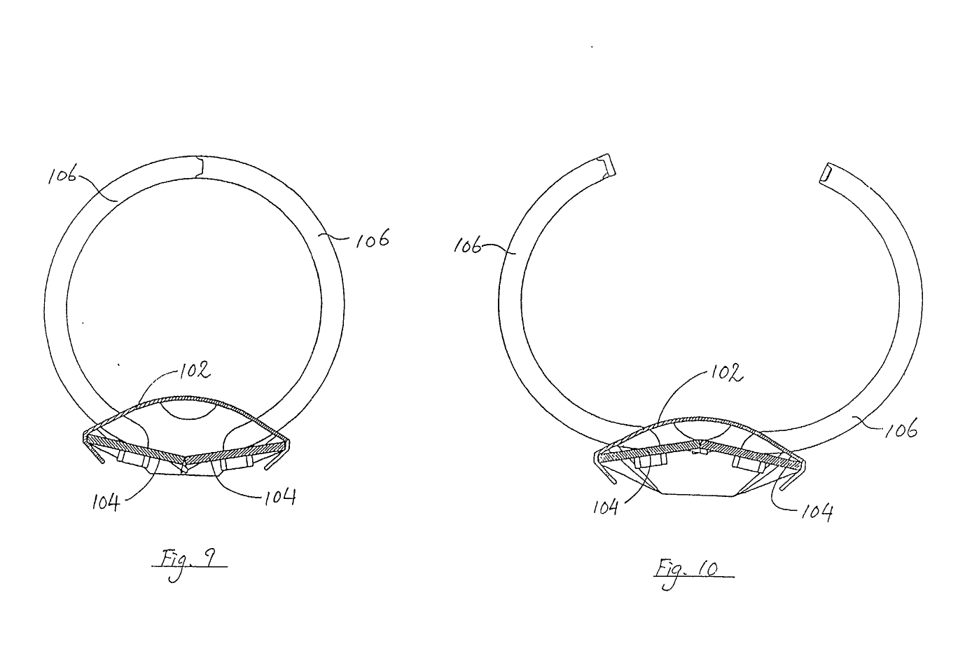

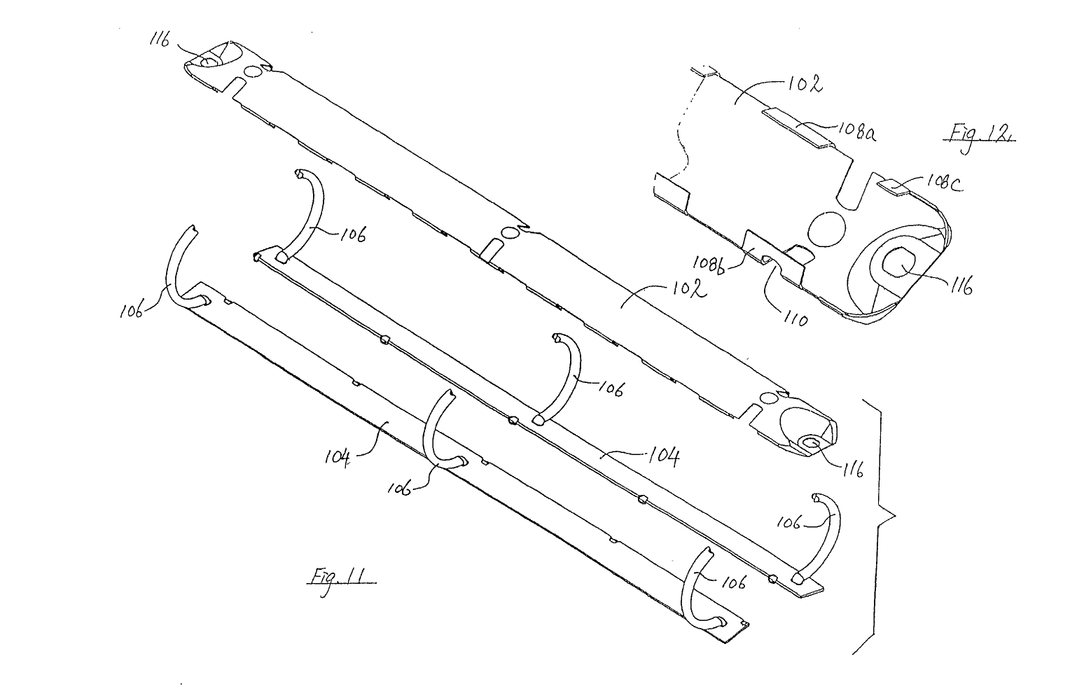

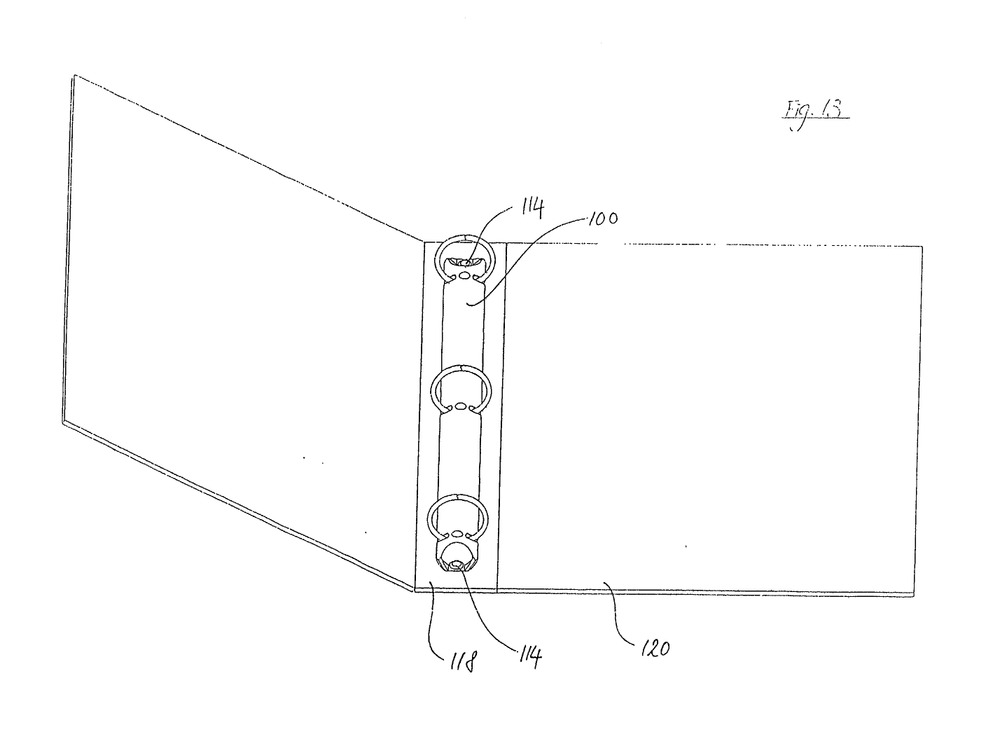

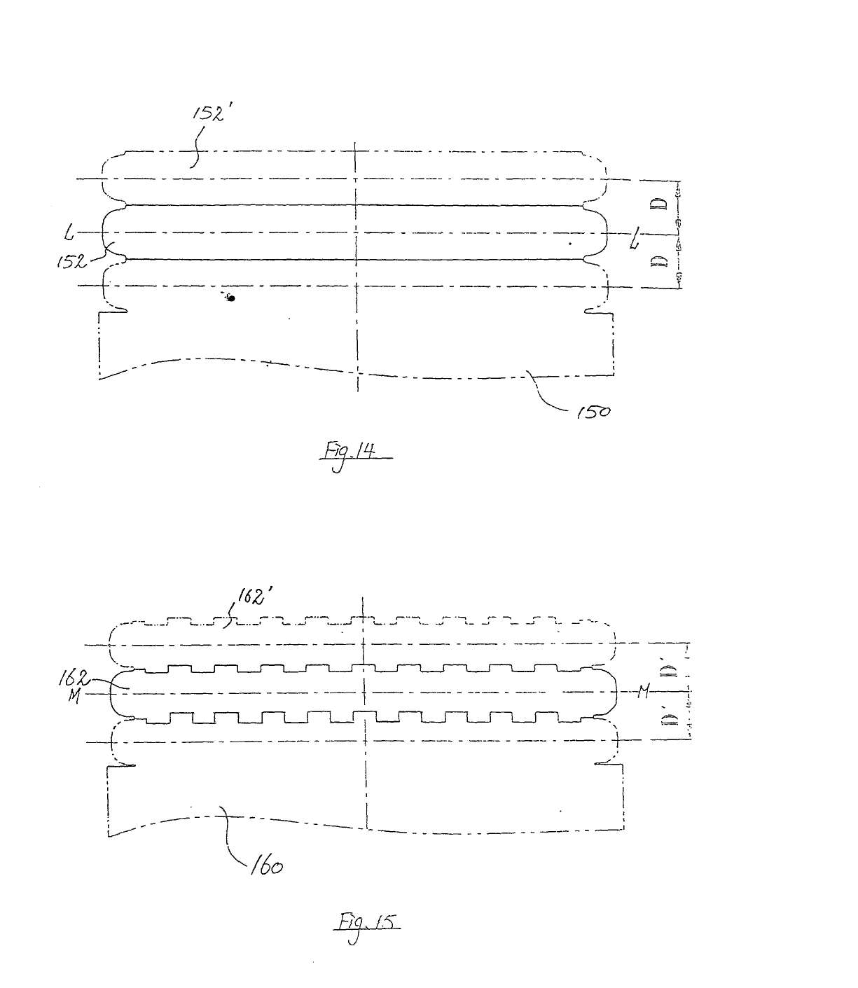

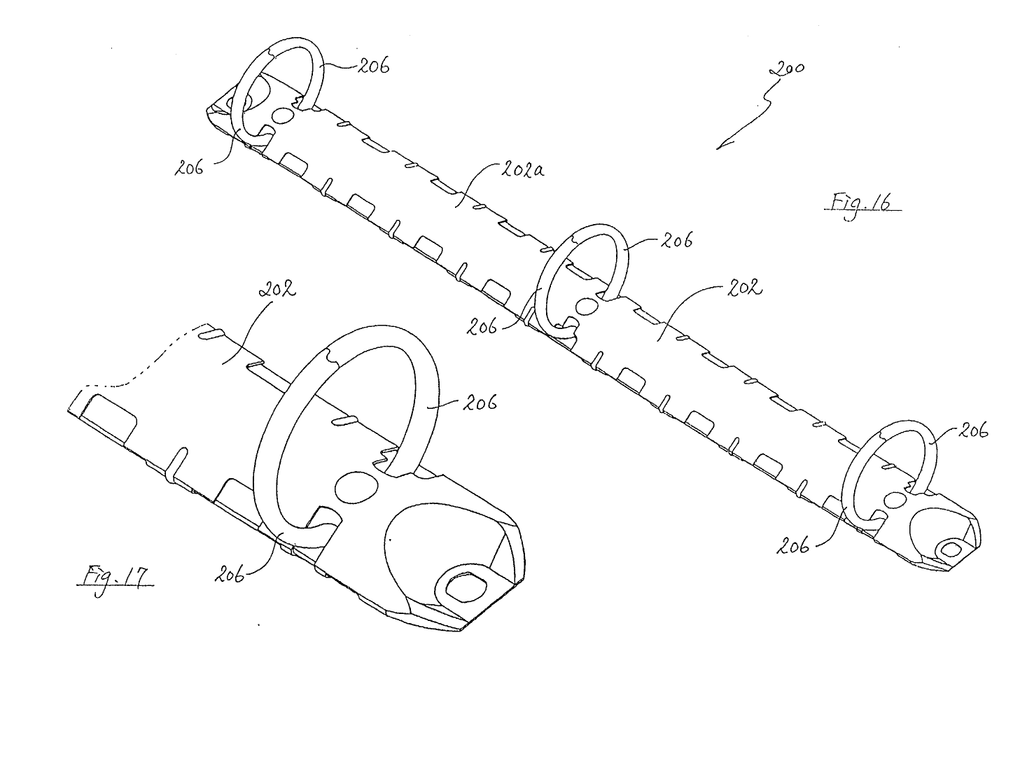

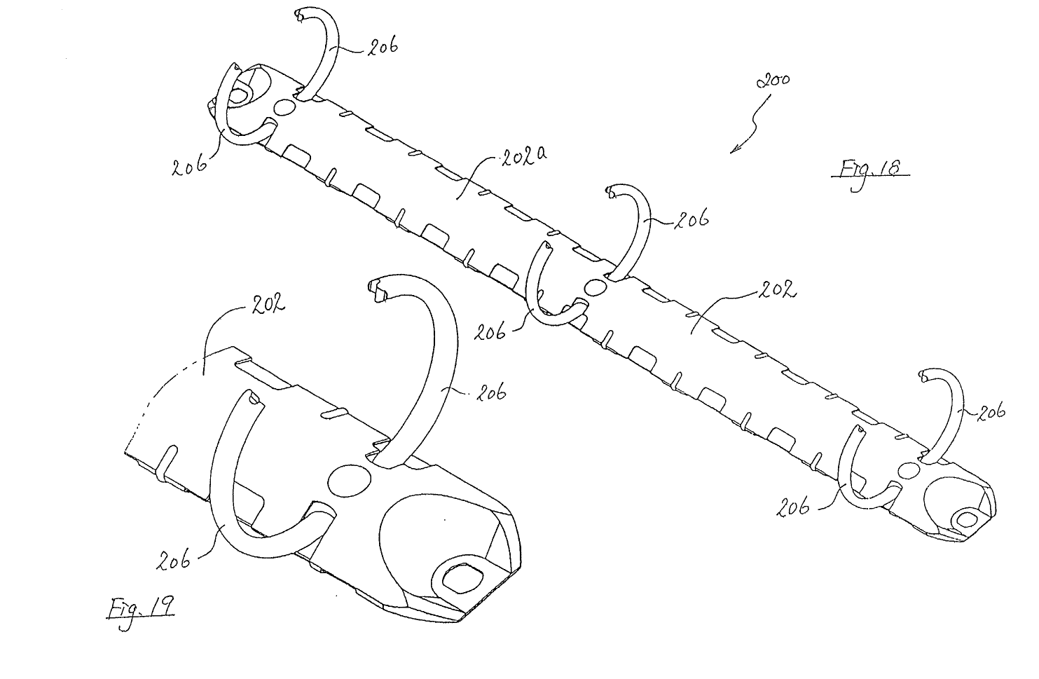

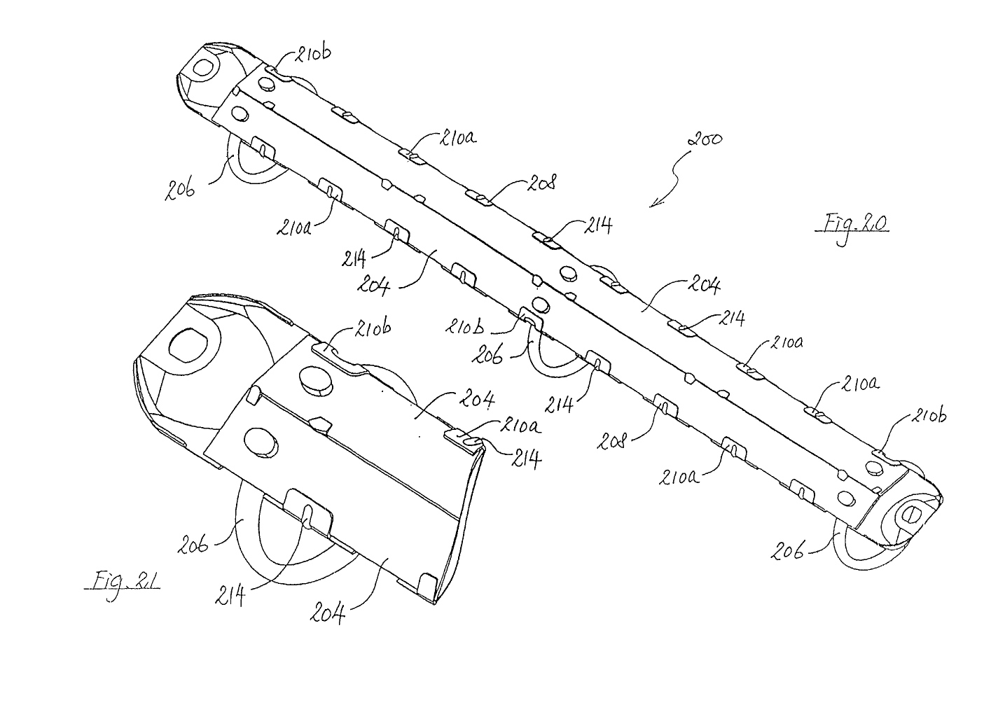

FIGS. 1 to 12 show a first embodiment of a ring binder mechanism according to the present invention, and generally designated as 100. The ring binder mechanism includes a curved upper housing or casing 102 which supports a pair of carrier rails 104. To each of the carrier rails 104 are fixedly mounted three half-rings 106. The carrier rails 104 may be pivoted relative to each other, e.g. by acting on the half-rings 106, to assume a first configuration in which the half-rings are closed, as shown in FIGS. 1, 2, 5, 6 and 9, and a second configuration in which the half-rings are open, as shown in FIGS. 3, 4, 7, 8 and 10.

As can be seen more clearly in FIGS. 5 to 8 and 12, a number of extensions 108a, 108b, 108c are provided on two lateral edges of the housing 102. The extensions 108a, 108b, 108c are bent downwardly, in the sense of FIGS. 9 and 10, and inwardly towards the central longitudinal axis of the housing 102. It can be seen that there are three types of extensions 108a, 108b, 108c. There are two extensions 108c and three extensions 108b. All the extensions 108c are provided on one lateral edge of the housing 102. As to the three extensions 108b, one is provided generally at the mid-point of the same lateral edge of the housing 102 as the extensions 108c. The other two extensions 108b are provided each adjacent to a longitudinal end of the ring binder mechanism 100 on the opposite lateral edge.

The extensions 108a, 108b are wider than the extensions 108c. While the extensions 108a and 108b are of substantially the same length, an opening 110 (see FIG. 12) transverse to the longitudinal axis of the housing 102 is provided in each extension 108b. When assembled, each of the opening 110 allows a half-ring 106 to pass through, and to move relative to the respective opening 110 during the relative pivotal movement of the carrier rails 104.

In FIG. 13, the ring binder mechanism 100 is secured, e.g. by rivets 114 received through holes 116 of the housing 102 of the ring binder mechanism 100, to a spine 118 of a cover 120, to form a ring binder.

Conventionally, and as shown in FIG. 14, the portion 152 surrounded by the solid line represents a part of a steel plate 150 to be cut out for the production of a housing for a ring binder mechanism. In this conventional arrangement, the portions 152 and 152′ are conjoined by a straight line which runs parallel to the longitudinal axis L-L of the portions 152, 152′, and thus the housings produced therefrom. On the other hand, according to the present invention, the portion 162 surrounded by the solid line in FIG. 15 represents a part of a steel plate 160 to be cut out for the production of a housing 102 for a ring binder mechanism 100.

It can be seen that the portion 162 has alternating tabs and recesses, in the form of a square wave, on each of both lateral sides. When the portion 162 is cut out, the tabs may then be bent inwardly towards each other, and towards the longitudinal axis M-M, to form a housing 102 (as shown in FIG. 12) for use in the ring binder 100 according to the present invention. The distance D between the two adjacent conventional portions 152, 152′ is larger than the distance D′ between the two adjacent portions 162, 162′, hence the savings in material used for the production of a housing 102 of the same size.

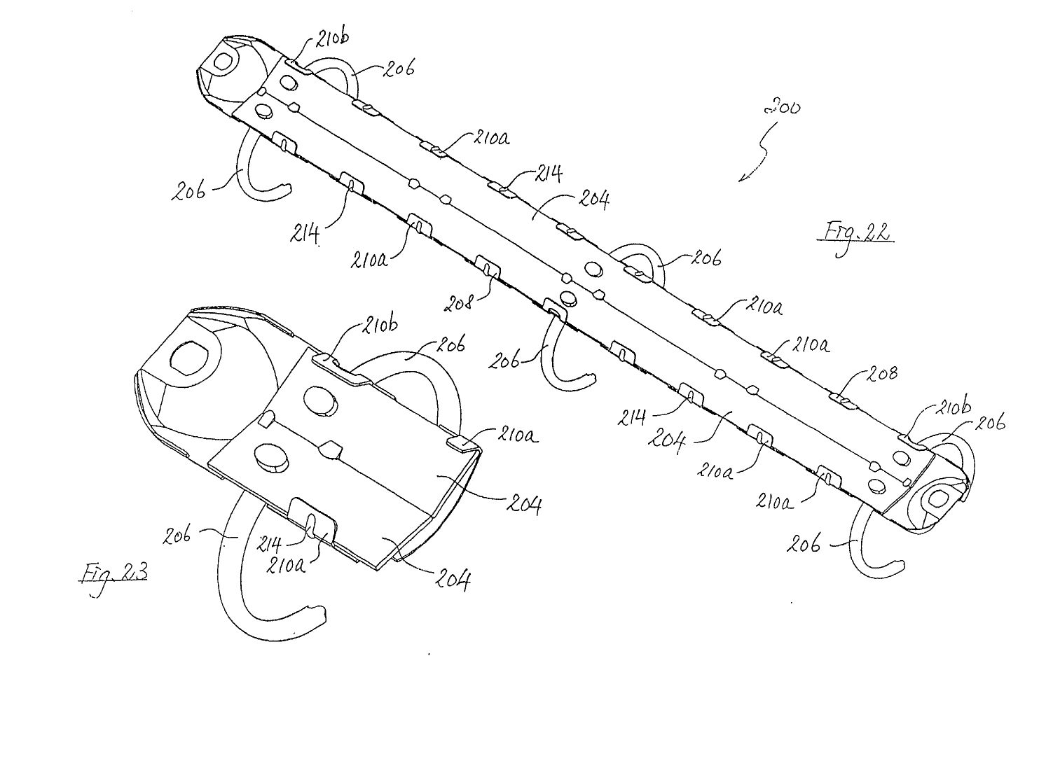

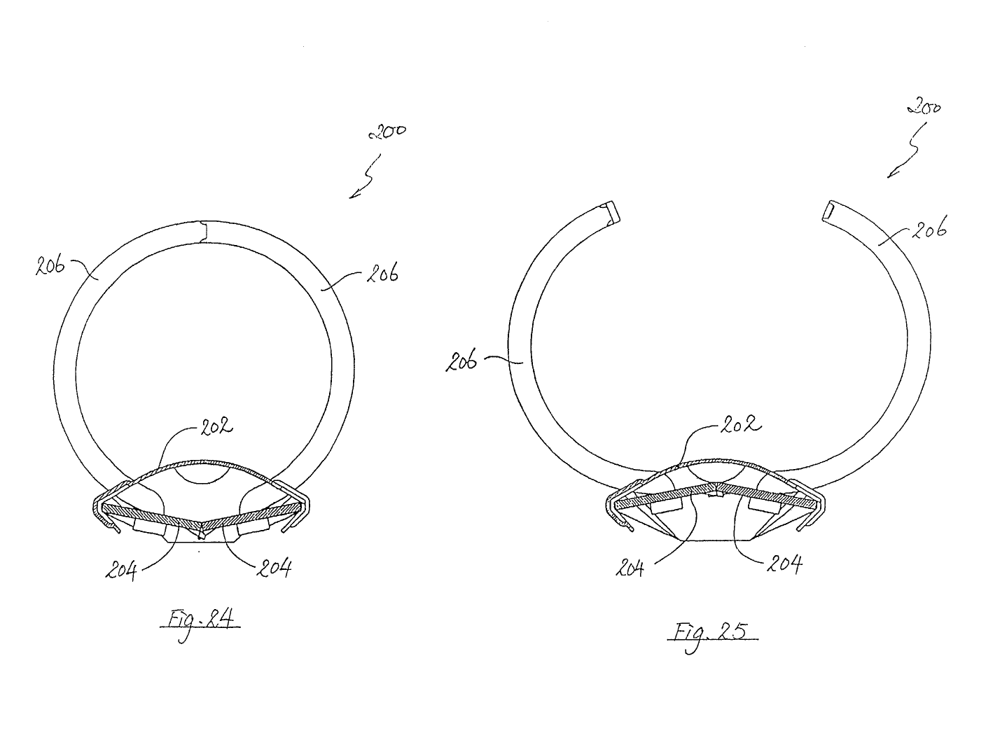

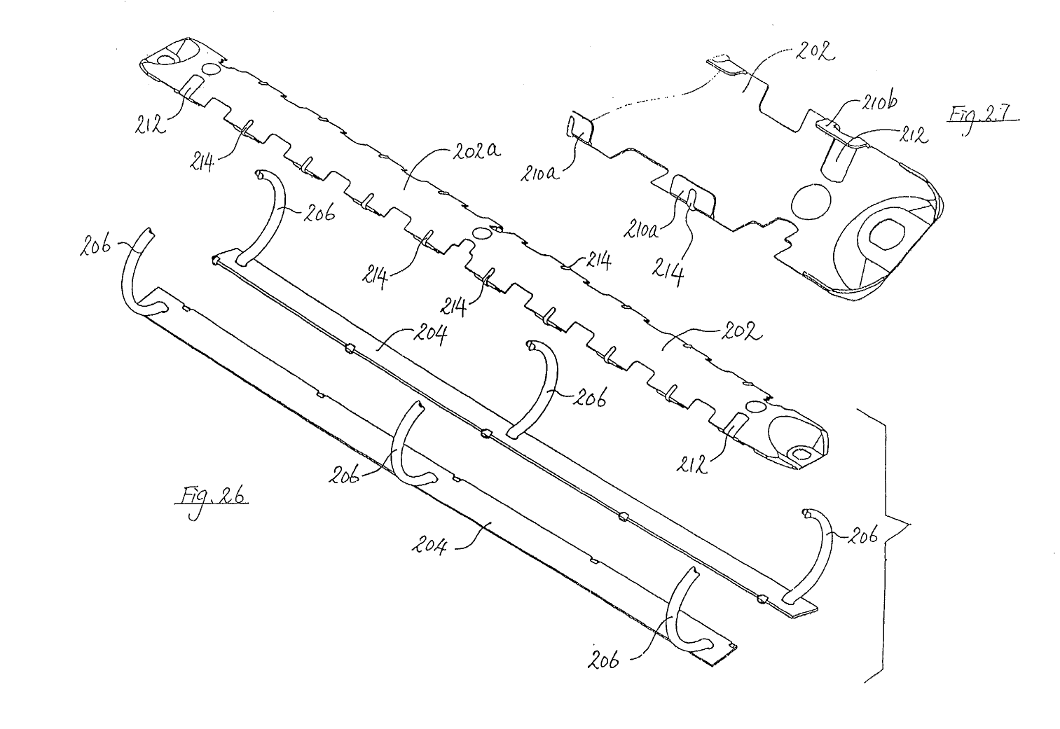

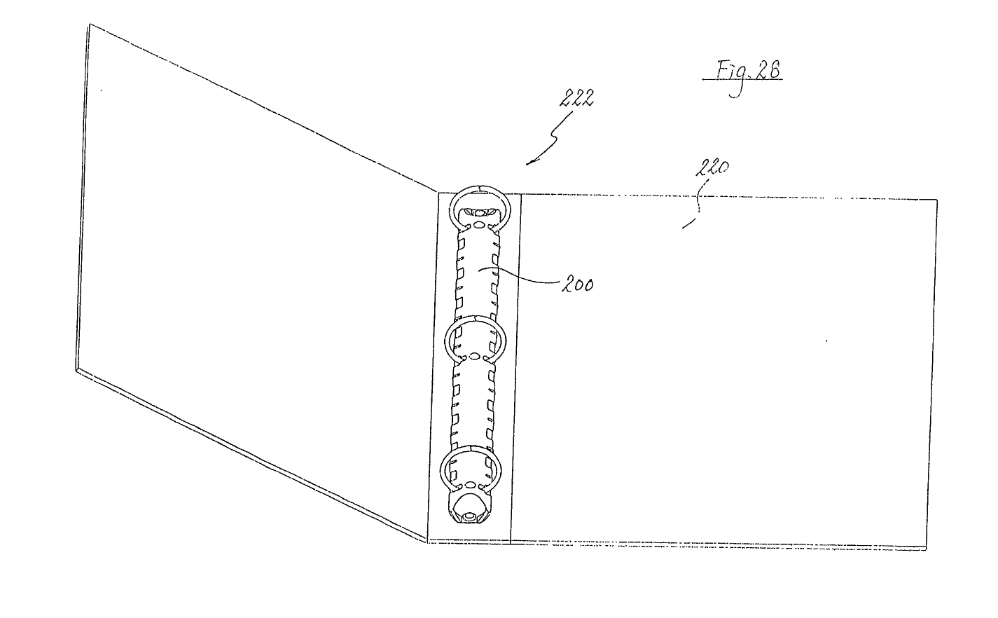

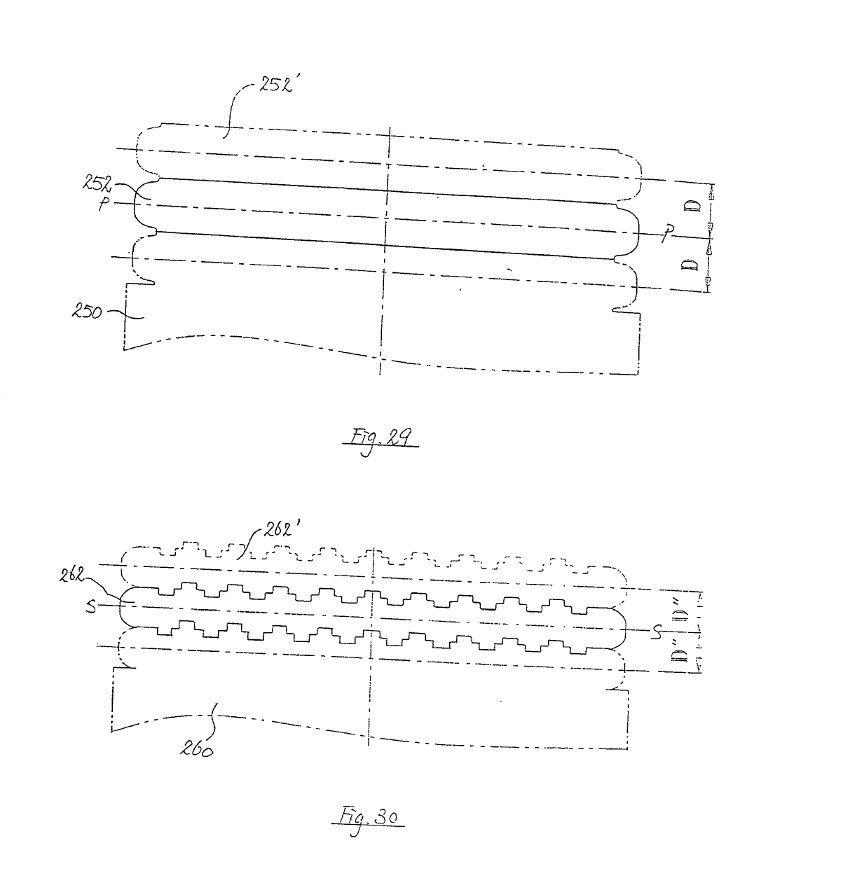

A second embodiment of a ring binder mechanism according to the present invention is shown in FIGS. 16 to 27, and generally designated as 200. The ring binder mechanism 200 includes a curved upper casing or housing 202 and a pair of carrier rails 204. Three half-rings 206 are fixedly secured to each of the carrier rails 204. As in the conventional manner, the carrier rails 204 are supported by the upper casing 202 for relative pivotal movements, such that the half-rings 206 may be opened or closed, as desired.

As can be seen in these figures, the upper casing 202 includes a top surface 202a which extends for the whole length of the ring binder mechanism 200. To each lateral side of the top surface 202a is a skirt portion 208, each comprising a number of tabs 210a, 210b. The tabs 210a, 210b are bent to extend generally towards the longitudinal axis of the housing 202. The tabs 210a, 210b, which constitute the skirt portions 208, collectively supports the carrier rails 204 for relative pivotal movement.

Each of the tabs 210b has an opening 212 which allows a respective half-ring 206 to pass through, such that the half-ring 206 moves relative to this opening 212 during the pivotal movement of the carrier rails 204. The opening 206 is elongate in shape and transverse to the longitudinal axis of the housing 202. In particular, the opening 206 extends from the top surface 202a of the housing 202 to the skirt portion 208.

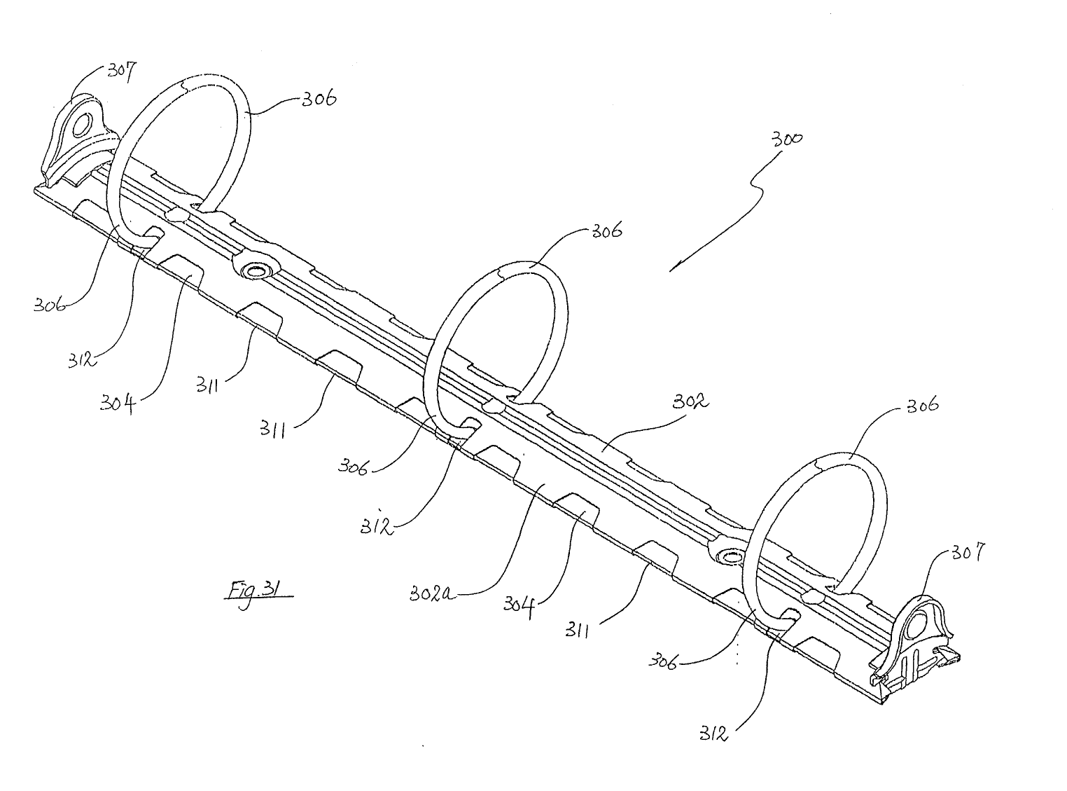

Each of the tabs 210a is provided with a ridge 214, which is transverse to the longitudinal axis of the housing 202, and extends from the top surface 202a of the housing 202 to the skirt portion 208. The purpose of the ridges 214 is to strengthen the tabs 210a. The same function may alternatively be achieved by provide a trough in each of the tabs 210a. As can be seen in FIG. 28, the ring binder mechanism 200 may be secured, e.g. by rivets, to a cover 220 to form a ring binder 222.

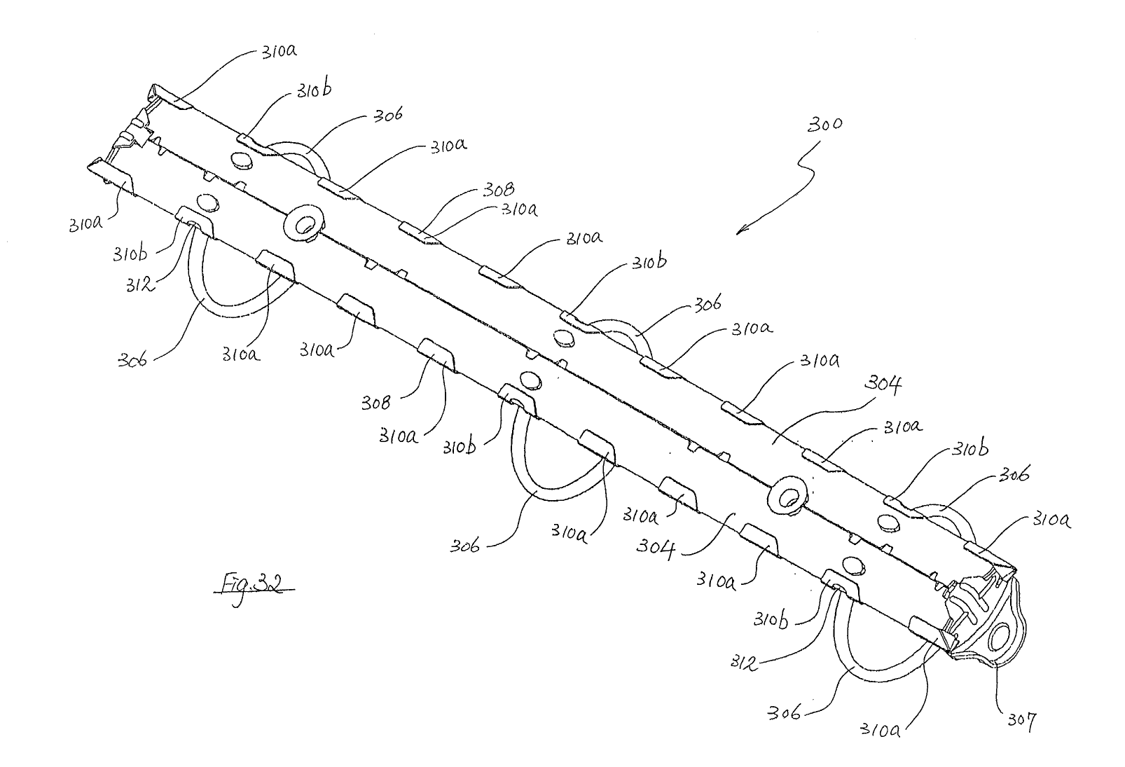

Conventionally, and as shown in FIG. 29, the portion 252 surrounded by the solid line represents a part of a steel plate 250 to be cut out for the production of a housing for a ring binder mechanism. In this conventional arrangement, the portions 252 and 252′ are conjoined by a straight line which runs parallel to the longitudinal axis P-P of the portions 252, 252′, and thus the housings produced therefrom. On the other hand, according to the present invention, the portion 262 surrounded by the solid line in FIG. 30 represents a part of a steel plate 260 to be cut out for the production of a housing 202 for a ring binder mechanism 200.

It can be seen that the portion 262 has alternating tabs and recesses on each of both lateral sides. When the portion 262 is cut out, the tabs may then be bent inwardly towards each other, and towards the longitudinal axis S-S, to form a housing 202 (as shown in FIG. 27) for use in the ring binder 200 according to the present invention. The distance D between the two adjacent conventional portions 252, 252′ is larger than the distance D″ between the two adjacent portions 262, 262′, hence the savings in material used for the production of a housing 202 of the same size.

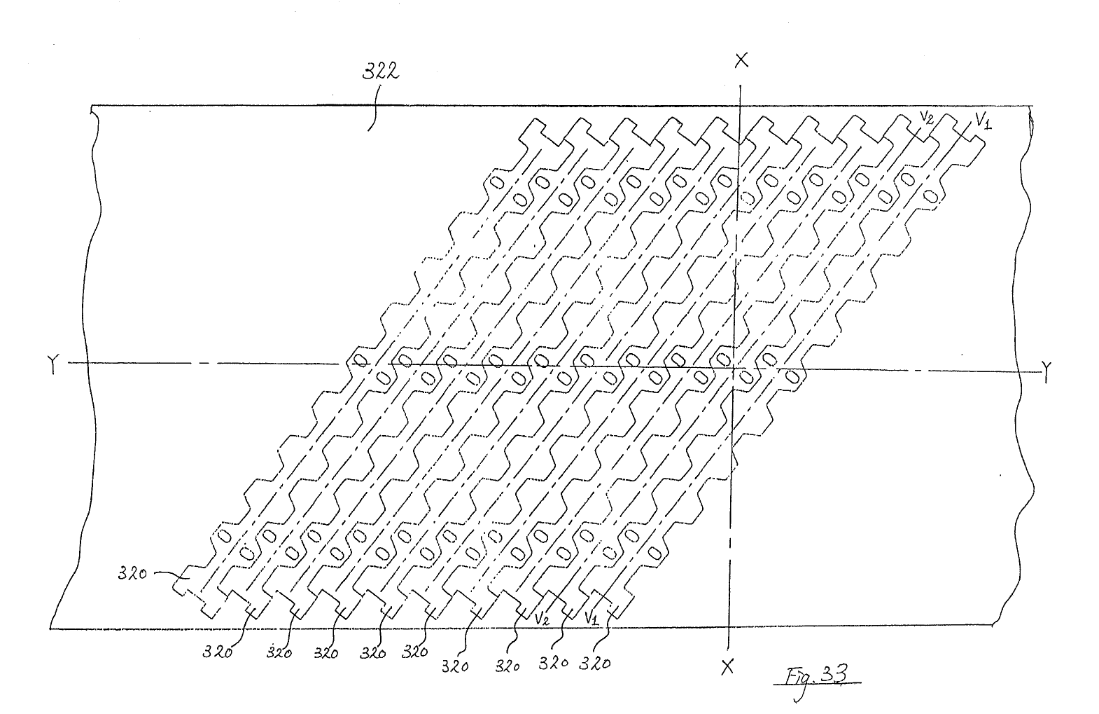

A third embodiment of a ring binder mechanism according to the present invention is shown in FIGS. 31 and 32, and generally designated as 300. The ring binder mechanism 300 includes a curved upper casing or housing 302 and a pair of carrier rails 304. Three half-rings 306 are fixedly secured to each of the carrier rails 304. As in the conventional manner, the carrier rails 304 are supported by the upper casing 302 for relative pivotal movements, such that the half-rings 306 may be opened or closed, as desired, by outward and inward pivotal movement of two levers 307, each situated at a longitudinal end of the ring binder mechanism.

As can be seen in these figures, the upper casing 302 includes a top surface 302a which extends for the whole length of the ring binder mechanism 300. To each lateral side of the top surface 302a is a skirt portion 308, each comprising a number of tabs 310a, 310b. The tabs 310a, 310b are bent to extend generally towards the longitudinal axis of the casing 302. The tabs 310a, 310b, which constitute the skirt portions 308, collectively support the carrier rails 304 for relative pivotal movement. It can be seen that part of the carrier rails 304, e.g. part of side edges 311 of the carrier rails 304, is exposed to the outside environment when the carrier rails 304 are supported by the upper casing 302.

Each of the tabs 310b has an opening 312 which allows a respective half-ring 306 to pass through, such that the half-ring 306 moves relative to this opening 312 during the pivotal movement of the carrier rails 304. The opening 306 is elongate in shape (see FIG. 34) and is transverse to the longitudinal axis of the housing 302. In particular, the opening 306 extends from the top surface 302a of the housing 302 to the skirt portion 308.

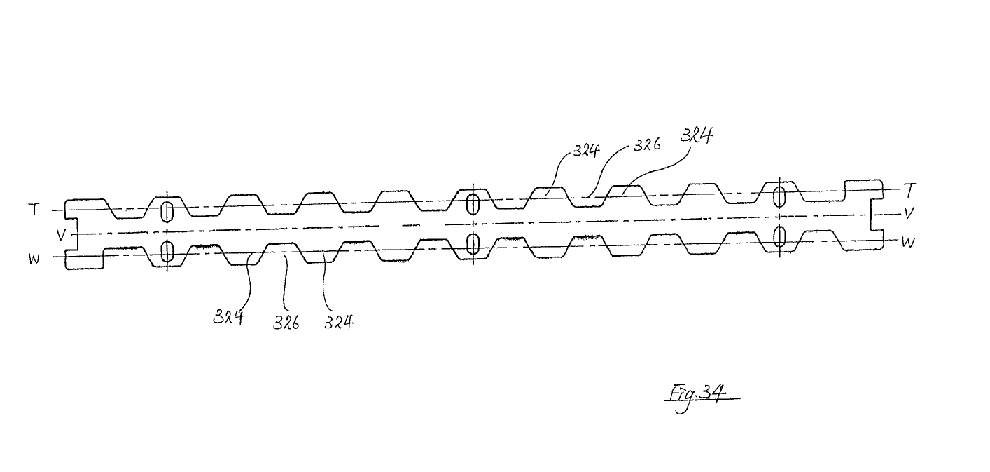

FIG. 33 shows the markings for cutting pieces of stainless steel platelets 320 from a large steel plate 322, for forming the housing 302 for the ring binder mechanism 300. It can be seen that the longitudinal axes of the platelets 320, e.g. V₁-V₁, V₂-V₂ as shown in FIG. 33, are slanted relative to the major axes X-X, Y-Y of the steel plate 322.

It can be seen from FIG. 34 that the platelet 320 has alternating tabs 324 and recesses 326 on each of the two lateral sides. When the platelet 320 is cut out from the plate 320, the tabs 324 may then be bent about the respective lines T-T, W-W inwardly towards each other, and towards the longitudinal axis V-V of the platelet 320, to form a housing 302 for use in the ring binder mechanism 300 according to the present invention. The lines T-T, W-W run parallel to the longitudinal axis V-V of the platelet 320.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

What is claimed is:

1. A housing member for a ring binder mechanism, wherein said housing member includes a plurality of tab members extending generally towards a longitudinal axis of said housing member.

2. A housing member according to claim 1 wherein at least one of said tab members includes an opening adapted to receive a half-ring member therethrough.

3. A housing member according to claim 1 wherein at least one of said tab members is provided with at least one ridge/trough member.

4. A housing member according to claim 3 wherein said ridge/trough member extends substantially transverse to the longitudinal axis of said housing member.

5. A ring binder mechanism including a housing member supporting a pivotable lower structure to which a plurality of half-ring members are mounted, wherein said housing member includes a plurality of tab members extending generally towards a longitudinal axis of said housing member, and wherein said lower structure is movable between a first configuration in which said half-ring members are closed and a second configuration in which said half-ring members are open.

6. A ring binder mechanism according to claim 5 wherein at least part of an upper surface of said lower structure is exposed to the outside environment.

7. A ring binder mechanism according to claim 5 wherein at least part of side edges of said lower structure is exposed to the outside environment.

8. A ring binder mechanism according to claim 5 wherein said tab members extend generally towards said lower structure.

9. A ring binder mechanism according to claim 5 wherein at least one of said half-ring members extends through an opening of one of said tab members.

10. A ring binder mechanism according to claim 5 further including at least a lever member movable to open and/or close said half-ring members.

11. A ring binder including a ring binder mechanism attached to a cover member, wherein said ring binder mechanism includes a housing member supporting a pivotable lower structure to which a plurality of half-ring members are mounted, wherein said housing member includes a plurality of tab members extending generally towards a longitudinal axis of said housing member, and wherein said lower structure is movable between a first configuration in which said half-ring members are closed and a second configuration in which said half-ring members are open.
